(19) United States
(12) Patent Application Publication
(10) Pub. No.: US 2018/0325046 A1
(43) Pub. Date: Nov. 15, 2018

(54) GROWING MEDIA AND METHOD FOR GROWING GRAPES IN AN ENCLOSED ENVIRONMENT

(71) Applicant: CANADIAN DISTRIBUTION CHANNEL, INC., Peterborough (CA)

(72) Inventors: Sharifi Medhi, West Kelowna (CA); Behrouz Khabbazi, Selwyn (CA)

(21) Appl. No.: 15/976,035

(22) Filed: May 10, 2018

(30) Foreign Application Priority Data
May 12, 2017 (CA) 2966913

(51) Int. Cl. A01G 22/05; A01G 24/22; A01G 24/28; C05D 1/00; C05D 5/00; C05F 11/04; C05F 17/00; C05G 1/00; C05G 3/06

(52) U.S. Cl. CPC A01G 22/05; A01G 24/22; A01G 24/28; C05D 1/00; C05G 3/06; C05F 11/04; C05F 17/0009; C05G 1/00; C05D 5/00

(57) ABSTRACT

Growing media for growing a grape variety in a controlled indoor environment, such as a greenhouse, where the growing media includes soil, at least one soil enhancer, which assists the soil in retaining nutrients and water and compost.

### FIELD OF THE DISCLOSURE

This disclosure generally relates to growing media for growing grapes in an enclosed environment, such as a greenhouse, and fertigation methods associated therewith.

### BACKGROUND

The global market for quality wine has increased as a result of wine consumption being promoted as a rich source of antioxidants.

Grape production in climates with harsh winters (including extreme negative temperatures such as but not limited to −30° C.) is compromised due to significant damage to grape vines which results in reestablishment of new vines taking 3-5 years from time of planting new root stock until first harvestable yield. “Winter injury” is freezing damage to wood and bud tissues of grapes vines caused when cold temperatures reach a critical level. Winter injury also occurs when the temperature drops below the critical level that each species can tolerate. Typically grape vine trunks are more cold tolerant than fruit buds. Damage can occur in the late fall of early winter if temperatures drop quickly. If temperatures increase or swing erratically over short periods of time during the winter, winter injury is more likely. In the case of severe winter injury, vines need to be replaced as discussed above. Furthermore, in humid temperature regions, for example in Canada, Crop Heat Units are typically low and growing seasons are typically short resulting in low grape yields. Crop Heat Units (“CHUs”) is an energy term calculated for each day and accumulated from planting to the harvest date. CHUs are calculated daily using the daily maximum and minimum temperature for a select area. However, time between sunrise and sunset, soil fertility and available water in the soil play an important role in the maturity and overall harvesting time. Low heat and low light conditions as well as short growing seasons and low yields are a problem in Canada. Ontario vineyards are expected to produce very little to no yield in the first two years and produce approximately 25% and 50% of full yields for years 3 and 4, respectively (Ministry of Agriculture 2014).

Furthermore, outdoor organic grape production is challenging due to pest, disease and weed pressure. There is a need for reducing the impact of outdoor conditions on growing grapes. There is a need to reduce the length of time for grape vine establishment. There is a need to reduce the need for agrochemical use in grape growing. There is a need for improving grape productivity, in one embodiment, in cool-humid regions, for example, but not limited to, Ontario, Quebec and Nova Scotia in Canada. There is a need to develop a grape growing media with nutritional, physical and biological properties amenable to growing grapes in an indoor environment.

### SUMMARY

According to one aspect, there is provided growing media for growing a deep root plant, preferably a grape variety in a controlled environment, preferably an enclosed environment, more preferably an indoor environment, even more preferably in a greenhouse or the like.

In one embodiment, said media comprises soil, preferably potting soil, at least one soil enhancer, preferably a soil enhancer which assists in said potting soil in retaining nutrients and water, preferably charcoal, more preferably porous charcoal, even more preferably biochar, and compost, preferably vermicompost and/or worm casting.

In one embodiment, said potting soil comprises sphagnum peat moss, coir, perlite, a wetting agent, at least one of the following: processed forest products, peat, and/or compost), and fertilizer.

In one embodiment, said fertilizer comprises Nitrogen (N), Phopshate (P₂O₅) and Potash (K₂O).

In a preferred embodiment, said Nitrogen is from ammoniacal nitrogen, nitrate nitrogen and combinations thereof.

In a preferred embodiment said Phosphate is available Phosphate.

In a preferred embodiment, said Potash is soluble Potash.

In a preferred embodiment, said potting soil comprises a minimum of N:P₂O₅:K₂O of 0.21:0.11:0.16.

In a preferred embodiment, said potting soil comprises a minimum of about 0.21% N, a minimum of about 0.11% P₂O₅ and a minimum of K₂O of about 0.16% based on F1144 analysis.

In a preferred embodiment, said minimum of about 0.21% N comprises about 0.113% ammoniacal nitrogen and about 0.097% nitrate nitrogen.

In a preferred embodiment, a portion of the Nitrogen, Available Phosphate and Soluble Potash are in a slow release form. Preferably said slow release form is coated Nitrogen, coated Available Phosphate and coated Soluble Potash. Preferably said slow release form provides 0.12% coated slow release Nitrogen, 0.04% coated slow release available phosphate and 0.08% coated slow release Potash. A slow release coating may be used that is known to a person of ordinary skill in the art.

In another embodiment, the Nitrogen, Phosphate and Potash are in organic form that slowly releases with decomposition of organic matter by microorganism action.

In a preferred embodiment, said biochar is charcoal produced from plant matter that can hold carbon in the soil. Biochar is produced through pyrolysis or gasification—processes that heat biomass in the absence (or under reduction) of oxygen. Biochar is a fine-grained, highly porous charcoal that helps soils retain nutrients and water. In a preferred embodiment, said vermipcompost is the product of the composting process using worms to create a mixture of decomposing vegetable or food waste, bedding materials, and vermicast.

Vermicast (also called worm castings) is the end-product of the breakdown of organic matter by worms such as an earthworm. Castings have been shown to contain reduced levels of contaminants and a higher saturation of nutrients than do organic materials before vermicomposting.

Vermicompost contains water-soluble nutrients and is an excellent, nutrient-rich organic fertilizer and soil conditioner.

In a preferred embodiment, said growing media comprises from about 30% to about 90% potting soil, preferably about 70% potting soil, from about 5% to about 30% biochar, preferably about 15% biochar and from about 5% to about 50% vermicompost (worm casting), preferably 15% vermicompost (worm casting).

In a preferred embodiment, said growing media further comprises Mycorrhizal fungi inoculant added at the onset of a first growth cycle. Preferably at a concentration of about 54 mg inoculant/L water.

In a preferred embodiment, said grape variety is selected from the group consisting of Frontenac Noir, Merlot, and Syrah.

In a preferred embodiment, said controlled environment is a greenhouse.

According to yet another aspect, there is provided a method and system for increasing berry count of a grapevine.

In a preferred embodiment, said method and system for increasing berry count of a grapevine is in a controlled environment, preferably an indoor controlled environment, more preferably a greenhouse.

According to yet another aspect, there is provided a method and system for increasing total berry weight of a grapevine.

In a preferred embodiment, said method and system for increasing total berry weight of a grapevine is in a controlled environment, preferably an indoor controlled environment, more preferably a greenhouse.

According to yet another aspect, there is provided a method and system for increasing berry clusters of a grapevine.

In a preferred embodiment, said method and system for increasing berry clusters of a grapevine is in a controlled environment, preferably an indoor controlled environment, more preferably a greenhouse.

In a preferred embodiment, said method and system comprise the use of growing media as described herein.

According to yet another aspect, there is provided a method of fertigation of grapes. Said method comprises introducing, over a predetermined period and predetermined frequency, at least one nutrient, preferably a plurality of nutrients, to growing media described herein. In one embodiment, said at least one nutrient comprises at least one nutrient selected from the group consisting of N, K, Ca, P, Mg, B, Fe, Mn, Zn, Cu, Mo, S and combinations thereof. In a preferred embodiment said at least one nutrient is selected from a combination of N, P, and K.

In a preferred embodiment said at least one nutrient further comprises a complexing agent, preferably citric acid.

In a preferred embodiment, said at least one nutrient is introduced to said growing media, preferably a combination of N, P, and K, and optionally citric acid, before, during or after at least a new grapevine is planted in said growing media.

In a preferred embodiment, said combination comprises 211 mg/L N (8.0%), 23 mg/L P (2.0%), 66 mg/L K (3%), available phosphate (2.0%), soluble potash (3.0%) and optionally citric acid (18.8%).

In a preferred embodiment said system further comprises supplemental nutrition comprising at least one nutrient selected from the group consisting of N, K, Ca, P, Mg, B, Fe, Mn, Zn, Cu, Mo, S and combinations thereof.

In a preferred embodiment, said supplemental nutrition comprises a mixture of N from about 63 to 210 ppm, K at about 235 ppm, Ca at about 200 ppm, P at about 31 ppm, Mg at about 48 ppm, B at about 0.5 ppm, Fe from about 1 to 5 ppm, Mn at about 0.5 ppm, Zn at about 0.05 ppm, Cu at about 0.02 ppm, Mo at about 0.01 ppm and S at about 64 ppm.

According to yet another aspect, there is provided a feeding regimen for an indoor grape growing system, said regimen comprising the introduction of a combination of N, P, K and citric acid on or about the first day of a growth cycle. Preferably, said combination comprises 211 mg/L N (8.0%), 23 mg/L P (2.0%), 66 mg/L K (3%), available phosphate (2.0%), soluble potash (3.0%) and optionally citric acid (18.8%).

Preferably said feeding regimen further comprises the introduction of a combination of N, K, Ca, P, Mg, B, Fe, Mn, Zn, Cu, Mo and S. Preferably a mixture of N from about 63 to 210 ppm, K at about 235 ppm, Ca at about 200 ppm, P at about 31 ppm, Mg at about 48 ppm, B at about 0.5 ppm, Fe from about 1 to 5 ppm, Mn at about 0.5 ppm, Zn at about 0.05 ppm, Cu at about 0.02 ppm, Mo at about 0.01 ppm and S at about 64 ppm.

In one embodiment, said combination is introduced to said system on day 1, day 14, day 18, day 28, day 42, day 68, day 71, day 83 and day 109 of said growth cycle.

In one embodiment, said mixture is introduced to said system on day 1, day 14, day 18, day 28, day 42, day 68, day 71, day 83 and day 109 of said growth cycle.

In any of the feeding regimens discussed herein, said growth cycle may be a first, second and beyond growth cycles.

In another embodiment, said method of growing deep root plants, preferably grapes comprises introduction of water to said system.

In another embodiment, said method of growing deep root plants, preferably grapes comprises control of climate conditions of said controlled environment. Preferably said controlled environment has a humidity level conducive to grape growing. One preferred level is from about 50-60% R.H. Preferably said controlled environment has a controlled CO₂ level, preferably a controlled CO₂ level at about 502 ppm. Preferably said controlled environment has a controlled temperature, preferably from between about 3° C. to about 27° C., depending on the period during the growth cycle. Preferably said controlled environment has a controlled lighting conditions, preferably a lighting length between about 8 hours to about 16 hours per day, depending on the period during the growth cycle. Preferably said controlled environment has a controlled dark conditions, preferably a dark length between about 8 hours to about 16 hours per day, depending on the period during the growth cycle. Preferably said lighting length provides solar radiation to said controlled environment, preferably about 700 μmol m⁻² s⁻¹.

In a preferred embodiment, said controlled lighting, dark and temperature conditions are as follows:

| | Day | Dark | | Solar |
|---|---|---|---|---|
| Days after | (Light) | (Night) | Temperature | Radiation |
| transplant of | Length | Length | Day/Night | Day/Night |
| grape vine | hours | hours | ° C. | μmol m⁻² s⁻¹ |
| 1 to 38 | 16 | 8 | 22/19 | 700/0 |
| 39 to 119 | 16 | 8 | 27/22 | 700/0 |
| 120 to 122 | 14 | 10 | 23/18 | 700/0 |
| 123 to 124 | 14 | 10 | 19/14 | 700/0 |
| 125 to 128 | 12 | 12 | 15/10 | 700/0 |
| 129 to 134 | 12 | 12 | 11/6 | 700/0 |
| 135 to 147 | 10 | 14 | 9/4 | 700/0 |
| 148 to 175 | 8 | 16 | 5/3 | 700/0 |

Deep root plants include grape vines, as well as other plants such as but not limited to:
1. the apple family including peaches;
2. walnuts, hazelnuts, almonds and pistachios; and
3. oranges, limes and lemons.

### BRIEF DESCRIPTION OF THE FIGURES

FIG. 1 is a depiction of the growth chamber layout of boxes.

FIG. 2 is a depiction of grape quality parameters for Frontenac Noir vines in their second growth cycle.

FIG. 3 is a depiction of Leaf count (left) and summer pruning dry weight (right) at day 76. Bars are means of four replications+/−SD. Bars with the same lower case letters are not significant at α=0.01 using Tukey test. Leaf count data was Logₑ to improve normally prior to analyses but is shown untransformed.

FIG. 4 depicts base vine area (left) and winter pruning wet weight (right) at day 168. Bars are means of four replications+/−SD. There was no statistically significant differences between treatments with either measurement.

FIG. 5 depicts soil nitrate (NO₃⁻), available phosphorous (Olsen P) and available potassium (K⁺) in amendment samples after harvest. Bars are means of four replications+/−SD. Bars with the same lower case letters are not significant at α=0.01 using Tukey test.

FIG. 6 depicts grape yield parameters for Frontenac Noir vines in their second growth cycle. The treatments were potting soil (control; FN-PS) and Biochar+Vermicompost (FN-BV). Values are means for each treatment. Columns sharing the same letter are not significantly different at 5% probability level using LSD test.

FIGS. 7A and 7B depict wine grape quality parameters for Frontenac Noir vines in their second growth cycle. The treatments were potting soil (control; FN-PS) and Biochar+Vermicompost (FN-BV). Values are means of for each treatment. Columns sharing the same letter are not significantly different at 5% probability level using LSD test.

FIGS. 8A and 8B depict growing media chemistry parameters including pH, ammonium-N and nitrate-N. Frontenac Noir vines were at the end of their second growth cycle while Syrah and Merlot vines were at the end of their first growth cycle. The treatments were Frontenac Noir vines in potting soil (control; FN-PS) and Biochar+Vermicompost (FN-BV), and Syrah and Merlot in Biochar+Vermicompost media (Syrah-BV and Merlot-BV). Values are means of for each treatment. Columns sharing the same letter are not significantly different at 5% probability level using LSD test.

### DETAILED DESCRIPTION

### Example 1—Growing of Frontenac Noir Wine Grape Variety in Various Growing Media

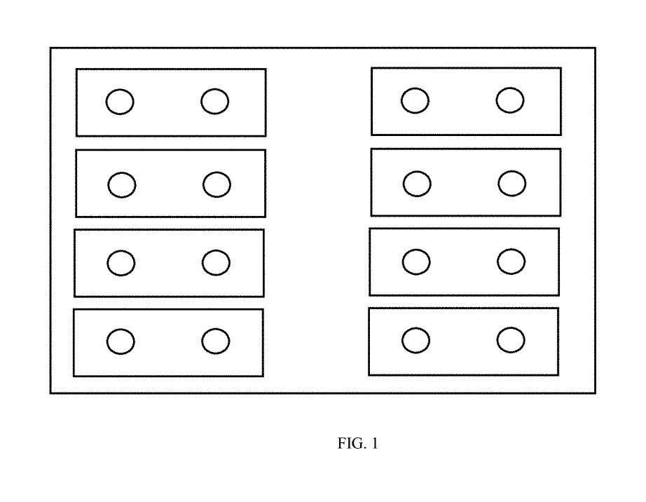

An objective was to assess grape vine establishment and growth during the first growth cycle in different growing media. The study was set up as a randomized block design (RCBD) with four blocks and four treatments. The treatments consisted of different growing media mixtures measure by volume: Control—100 potting soil (Miracle-Gro® Moisture Control® Potting Mix); BC—70% potting soil, 30% Biochar; VC—70% potting soil, 30% vermicompost (worm casting); and BC+VC—70% potting soil, 15% Biochar and 15% vermicompost (worm casting). Biochar was sourced from Burt's Greenhouses, Odessa, Ontario. Vermicompost was sourced from Greenscience Technologies Inc., Toronto, Ontario. Micro-environmental chambers at Trent University School of Environment were used for this study. Eight experimental units were fit in each chamber (see FIG. 1). FIG. 1 represents a single micro-environment chamber containing eight experimental units or treatments or planter boxes (16 vines). A column of four planter boxes is defined by a block and each block contains one replication of each treatment. Each experimental unit (box) contains two Frontenac Noir vines (circles). A block was defined as one column of treatments on one side of a chamber. Each treatment consisted of a planter box with inner dimensions of 41 cm wide, 86.5 cm long and 24 cm high. Two 1 cm inner diameter drainage holes were installed at the base of each planter box with a plastic spout at each hole allowing for drainage water to be collected. Drainage water was recycled back to the treatment growth media as to reduce leaching of nutrients from the growth media. The bottom of each planter box (treatment box) was filled with sand (5 cm thick) to facilitate drainage. Each planter box was then filled to the top with growing media (this left about 10 cm between the top of the growing media and the top of the planter box once the growing media had settled). Two Frontenac Noir vines (grafted on a cross riparia and rupestris rootstock) were planted in each planter box. Each treatment box had two 80 cm lengths of “soaker tube” buried 5 cm deep at both sides of each vine in each box, supplying subsoil irrigation. Water lines were connected to water (municipal water) within the chamber and controlled with a daily digital timer. Watering rates varied throughout the experimental time period and were adjusted accordingly to keep the growing media moist (field capacity) but not saturated. Treatments that demanded more water were spot watered as needed. The amount of water used for irrigation was recorded.

Treatments were set up and Frontenac Noir vine root stocks were planted in mid-December (day 1). Room climate conditions contained a day and night cycle with an immediate transition threshold. For the first 38 days of the experiment, day (light) conditions were set to 16 hour lengths, 22.5° C., and 700 μmol m⁻² s⁻¹ solar radiation. For the first 38 days of the experiment, night (dark) conditions were set to 8 hour lengths, 19.5° C., and 0 μmol m⁻² s⁻¹ solar radiation. From day 39 to day 115 of the experiment, day (light) conditions were set to 16 hour lengths, 27° C., and 700 μmol m⁻² s⁻¹ solar radiation. From day 39 to day 115 of the experiment, night (dark) conditions were set to 8 hour lengths, 22° C., and 0 μmol m⁻² s⁻¹ solar radiation. Humidity was maintained around 60% R.H. On day 116, day (light) and night (dark) temperature conditions were decreased by 2° C. per day, five days a week until day temperatures reached 7° C. and night temperatures reached 2° C. on day 128. Day temperatures were lowered by 1° C. per day from day 131 to 134 so that day temperatures reached 3° C. and night temperatures stayed at 2° C., this temperature was maintained during the dormancy phase.

Treatments were initially fertilized immediately after planting with 6 L of dilute Dutch Nutrient Formula PNK fertilizer (211 mg N L⁻¹, 23 mg P L⁻¹, 66 mg K L⁻¹). 1 L of Hoagland solution (N 210 ppm, K 235 ppm, CA 200 ppm, P 31 ppm, S 64 ppm, Mg 48 ppm, B 0.5 ppm, Fe 2.5 ppm, Mn 0.5 ppm, Zn 0.05 ppm, Cu 0.02 ppm, Mo 0.01 ppm) was added to each treatment to avoid nutrient deficiencies. On day 68 and day 74, 250 ml of Hoagland solution was added to each experimental unit or planter box.

Plant growth observations were collected for each treatment once a week from day 39 to day 75. On each observation day, a photograph was taken, new growth was measured, number of leaves were counted for each plant and plant leaf colour and general health was noted for each plant. In some replications, one of the root stocks never sprouted and was replaced with new root stock on day 39. Only the larger of the two treatment vines was reported to avoid averaging small, late growing vines. Vines were pruned twice during the first growth cycle. Summer pruning was conducted on day 76. Winter pruning was conducted on day 168. Pruned vegetation was sorted by treatment, dried at 60° C. for 48 hours, weighed and recorded as pruning dry weight.

A few grape clusters appeared on some vines and were harvested when ripe. All grapes were counted and weighed. Brix was measured for each replication that grew fruit. In all but one treatment, yield was too small for additional analyses. Block III BC+VC treatment had high enough yield for additional analyses. Grapes were crushed by hand in a beaker and solids were separated from juice using 106 μm steel mesh. Grape juice pH was measured using pH probe and TA was measured by NaOH titration.

After harvest, samples were collected from the growth media of each treatment. Soil probes were used to take 2 soil cores from opposite corners of each planter box (low sample volumes were taken to avoid damaging vine roots). Samples were sieved to <2 mm, moist samples were immediately analyzed for mineral N, the rest of the sample was air dried and stored in seal plastic bags until analyses. Growth media were analyzed for electrical conductivity (EC) and pH (1:4 soil to TRO water ratio) using a conductivity and pH probe, organic matter content using loss on ignition (LOI) method by heating a sample to 550° C. for 6 hours, mineral N by extracting media with 2M KCl (1:10 soil to solution ratio) followed by supernatant analysis via colourimietry using a Lachat FIA (Flow Injection Analyzer), Olsen P by extraction soil with 0.5M NaHCO₃ adjusted to pH 8.5 (1:20 soil to solution ratio) followed by supernatant analysis via colourimetry using a Lachat FIA. Exchangeable cations by extraction with 1M NH₄OAc adjusted to pH 7, (1:5 soil to solution ratio) followed by supernatant analysis on a flame atomic adsorption spectrometer.

### Media Chemistry Data

Day 75 leaf count data and pruning weight data was logₑ transformed when it improved normality (EC, LOI, NO₃₋, Na⁺, Ca⁺, Mg²⁺, leaf count) but is shown untransformed graphically for ease of interpretation. Data that was bimodal and poorly adhered to statistical assumption of normality (pH, Olsen P, extractable K and pruning dry weight) were rank transformed. Rank transformation decreased statistical power. Assumption of normality was relaxed form bimodal data. All alpha values were set at 0.01 to lower the chance of a Type I error. Data were analyzed using one way ANOVA test and if significant (α=0.01), data were analyzed with a Tukey test. Leaf counts data and length of new vine growth data over time heavily violated assumptions of normality and homoscedasticity for repeated measures ANOVA and was used descriptively.

### Results

### Vine Establishment and Growth

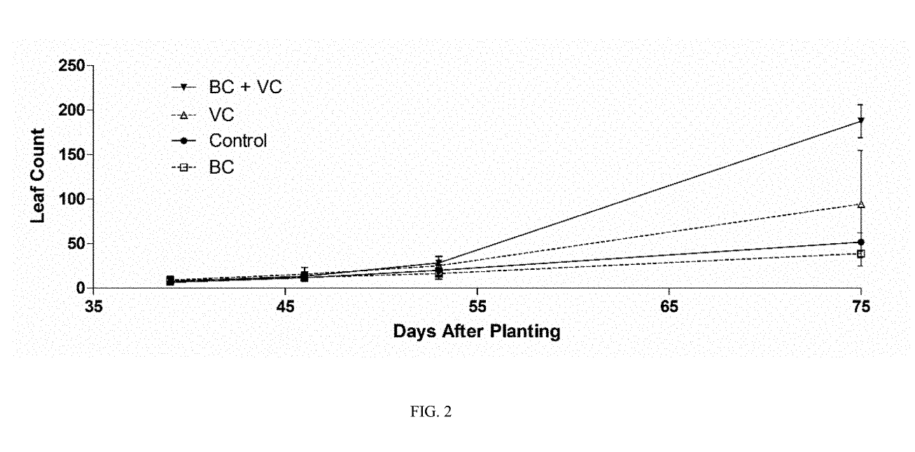

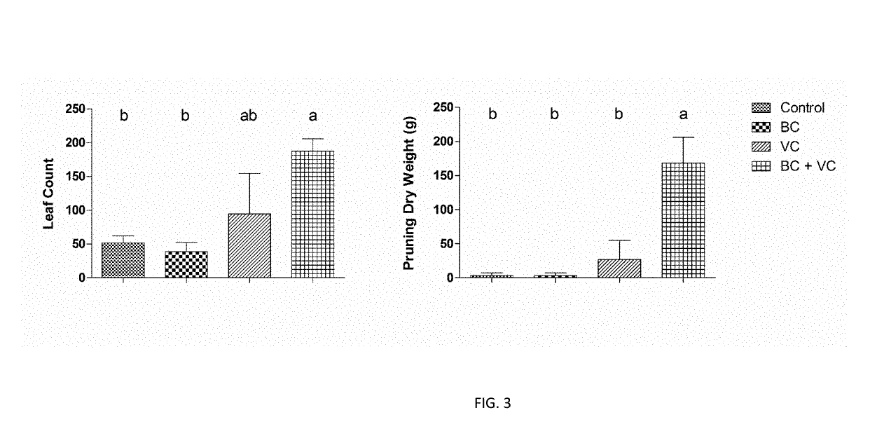

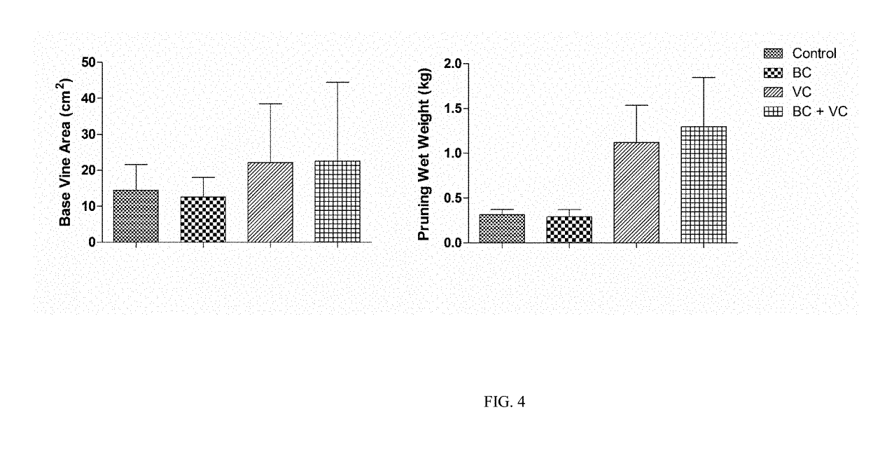

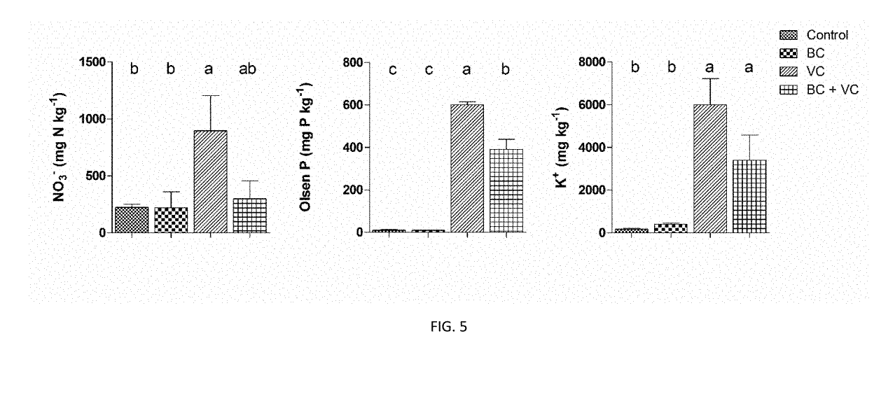

Leaf count in the BC+VC treatment were significantly higher than the Control and BC on the 75^{th} day of growth (FIG. 2). Pruning weights in the BC+VC treatment were significantly higher than all other treatments on the 76^{th} day of growth. BC and VC treatments were more common to sow signs of yellowing leaves whereas the Control and VC+BC treatments consistently had bright green leaves. Base vine area and winter pruning wet weight at day 168 were measured. A trend towards higher Base vine area and winter pruning wet weight at VC and BC+VC treatments was observed compared with Control and BC treatments. The measured available nutrients were higher in BC+VC treatments compared with Control and BC.

### Growth Media Chemistry

Concentrations of available nutrients were measured in growing media's components (Biochar and vermicompost) before start of the experiment (Table 1). Growing media EC (salt concentration indicator) and pH (acidity indicator) and concentration of nutrients were measured in growing media after harvest (Table 2). These parameters were significantly higher for BC+VC compared with BC and Control treatments except for LOI (loss on ignition) that is representative of total carbon and was higher in BC than other treatments.

TABLE 1
Amendments Chemical Properties

| | LOI | NO₃ | Olsen P | K⁺ | Na⁺ | Ca²⁺ | Mg²⁺ |
|---|---|---|---|---|---|---|---|
| Amendment | (%) | (mg N kg⁻¹) | (mg P kg⁻¹) | (mg kg⁻¹) | (mg kg⁻¹) | (mg kg⁻¹) | (mg kg⁻¹) |
| Biochar | 93.7 | <DL | 20.7 | 1583 | 174.3 | 3795 | 611.2 |
| Vermicompost | 62.7 | 488.0 | 575.0 | 6707 | 1591 | 4751 | 1628 |

TABLE 2
Selected growing media chemical properties (n =
4). Data in the brackets are Standard deviation (SD).

| | EC | | | Na⁺ | Ca²⁺ | Mg²⁺ |
|---|---|---|---|---|---|---|
| | (mS | | LOI | (mg | (mg | (mg |
| Treatment | m⁻¹) | pH | (%) | kg⁻¹) | kg⁻¹) | kg⁻¹) |
| (Control) | 66 | 5.79 | 66.5 | 234 | 16152 | 1181 |
| | (12) b | (0.08) b | (6.6) b | (48.6) b | (1549) | (92.6) b |
| BC | 81 | 5.69 | 87.6 | 308 | 18210 | 1393 |
| | (34) b | (0.18) b | (2.0) a | (33.9) b | (246) | (80.1) b |
| VC | 238 | 6.27 | 67.2 | 1014 | 15025 | 2451 |
| | (74) a | (0.10) a | (2.2) b | (218.0) a | (630) | (159.5) a |
| BC + VC | 112 | 6.28 | 74.7 | 711 | 16985 | 2163 |
| | (40) ab | (0.05) a | (2.4) b | (198.5) a | (205) | (221.2) a |

### Quality

Grape quality parameters were measured in few clusters produced. Brix was in optimum range and TA was high where data was available (Table 3). Berry weight, berry count and grape Brix were higher for the BC+VC treatment.

TABLE 3
Grape data. Values are means of treatments
when data was available

| | Replications | | | | | Grape |
|---|---|---|---|---|---|---|
| | which | Berry | | | | Titratable |
| Treat- | Produced | Weight | Berry | Grape | Grape | Acidity |
| ment | Grapes | (g) | Count | Brix | pH | (g/L) |
| Control | 2 | 5 | 7 | 21 | | |
| BC | 0 | | | | | |
| VC | 1 | 4 | 3 | 20 | | |
| BC + | 1 | 67 | 75 | 24 | 4 | 17 |
| VC | | | | | | |

Grapes were successfully grown under indoor controlled environment conditions and growing media consisting of organic amendment mixtures. Nutrients supplied by BC+VC treatments fully supported the vine growth during the period of the experiment. The amounts of supplemental fertility added to the treatments during the experiment were minimal. BC+VC treatment hold on to the nutrients more efficiently compared with VC. BC treatment performed better than control but resulted in lower growth than BC+VC and some minor deficiency symptoms in vines.

### Example 2—Assessment of Growing Media and Fertigation Regimes of Frontenac Noir, Merlot and Syrah Wine Grape Varieties

The study was set up as a randomized complete block design (RCBD) with four blocks of three wine grape varieties: Frontenac Noir, Merlot and Syrah; and four replications. Frontenac Noir vines were in the 2^{nd} growth cycle and were grown in two different growing media: Control—100% potting soil (Miracle-Gro® Moisture Control® Potting Mix) and BV—70% potting soil (Miracle-Gro® Moisture Control® Potting Mix), 15% Biochar and 15% Vermicompost (worm casting). Merlot and Syrah vines were grown in BV growing media.

Biochar was sourced from Burt's Greenhouses, Odessa, Ontario for Frontenac Noir vines, and from Basque Charcoal, Rimouski, Quebec for Merlot and Syrah vines. Vermicompost (worm casting) was sourced from Greenscience Technoloiges Inc., Toronto, Ontario. Micro-environmental chambers at Trent University School of Environment with capability of controlled light, moisture (humidity) and temperature were used for the study. Eight experimental units were fit in each chamber. A block was defined as one column of treatments on one side of a chamber. Each treatment consisted of a planter wooden box with inner dimensions of 41 cm wide, 86.5 cm long, 24 cm high. Two 1 cm inner diameter drainage holes were installed at the base of the planter box with two plastic spouts attached to them which allowed drainage water to be collected. Drainage water was returned back to the treatment growth media as to not leach the media of nutrients. The bottom of each treatment box was filled with 5 cm of sand to facilitate drainage. Treatment boxes were filled to the top with their respective media (this left about 10 cm between the top of the media and the top of the planter box after the media had settled).

The planter boxes with Frontenac Noir vines carried on from previous phase of the experiment (Phase I). The Syrah and Merlot vines boxes (8) were carefully mixed and filled with 36 L potting soil+8 L Biochar+8 L Vermicompost+Mycorrhizal inoculant (˜55 mg/planter box as recommended on the package) (BV). Two vines were planted in each experimental unit (box). Treatments and labelling are depicted below in Table 3.

TABLE 3
Treatments and labelling system.

| | Labelling System | | | | | |
|---|---|---|---|---|---|---|
| Chamber | Box | Growing | | | | |
| # | # | Media | Variety | Trt# | Rep# | Labels |
| 2 | 1 | Control | FN | 1 | 1 | CDC-FN-1-1-1 |
| 2 | 2 | Control | FN | 1 | 2 | CDC-FN-2-1-2 |
| 3 | 3 | Control | FN | 1 | 3 | CDC-FN-3-1-3 |
| 3 | 4 | Control | FN | 1 | 4 | CDC-FN-4-1-4 |
| 2 | 5 | BV | FN | 2 | 1 | CDC-FN-5-2-1 |
| 2 | 6 | BV | FN | 2 | 2 | CDC-FN-6-2-2 |
| 3 | 7 | BV | FN | 2 | 3 | CDC-FN-7-2-3 |
| 3 | 8 | BV | FN | 2 | 4 | CDC-FN-8-2-4 |
| 2 | 9 | BV | Syrah | 3 | 1 | CDC-S-9-3-1 |
| 2 | 10 | BV | Syrah | 3 | 2 | CDC-S-10-3-2 |
| 3 | 11 | BV | Syrah | 3 | 3 | CDC-S-11-3-3 |
| 3 | 12 | BV | Syrah | 3 | 4 | CDC-S-12-3-4 |
| 2 | 13 | BV | Merlot | 4 | 1 | CDC-M-13-4-1 |
| 2 | 14 | BV | Merlot | 4 | 2 | CDC-M-14-4-2 |
| 3 | 15 | BV | Merlot | 4 | 3 | CDC-M-15-4-3 |
| 3 | 16 | BV | Merlot | 4 | 4 | CDC-M-16-4-4 |

FN: Frontenac Noir
BV: Biochar + Vermicompost + Mycorrhizae
Rep = Replication;
Trt = Treatment

### Irrigation System

At the start of the experiment (September 2016), each treatment had two 80 cm lengths of “soaker tube” buried 5 cm deep at both side of two vines in each box, supplying subsoil irrigation. Water lines were connected to municipal water tap within the chamber and controlled with a daily digital timer. Watering rates varied throughout the experimental time period and were adjusted to keep soil moist (field capacity). Treatments that demanded more water were spot watered with a watering can in addition to irrigation. The amount of water used for irrigation was recorded. In average, freshly planted vines (2 vines/box) require 4 L of water every 3 days; the fully grown vines require at least 14 L of water every 3 days. Watering was done manually 9 L of water every 3 days to old grape vines, and 4 L of water every 3 days to new grape vines, until they reached day 39, and then they switched to 9 L/3 days schedule.

### Micro-Environmental Chamber Conditions

Growth room climate conditions contained a day and night cycle with an immediate transition threshold (Table 4). Humidity in the chambers was not controlled but was generally remained around 50-60% and CO₂ at 502 ppm. On day 120, day and night temperatures were decreased by 2° C. per day, five days a week until day temperatures reached 5° C. and night temperatures reached 3° C. This temperature was maintained for 900 hr (average chilling hours requires for the varieties).

TABLE 4
Growth chamber climate conditions during the experiment.

| Days after | | Temperature | Solar Radiation |
|---|---|---|---|
| transplant | | (° C.) | (μmol m⁻² s⁻¹) |
| Day 1 to 38 | | | |
| Day Length | 16 hours | 22° C. | 700 |
| Night Length | 8 hours | 19° C. | 0 |
| Day 39 to 119 | | | |
| Day Length | 16 hours | 27° C. | 700 |
| Night Length | 8 hours | 22° C. | 0 |
| Day 120 to 122 | | | |
| Day Length | 14 hours | 23° C. | 700 |
| Night Length | 10 hours | 18° C. | 0 |
| Day 123 to 124 | | | |
| Day Length | 14 hours | 19° C. | 700 |
| Night Length | 10 hours | 14° C. | 0 |
| Day 125 to 128 | | | |
| Day Length | 12 hours | 15° C. | 700 |
| Night Length | 12 hours | 10° C. | 0 |
| Day 129 to 134 | | | |
| Day Length | 12 hours | 11° C. | 700 |
| Night Length | 12 hours | 6° C. | 0 |
| Day 135 to 147 | | | |
| Day Length | 10 hours | 9° C. | 700 |
| Night Length | 14 hours | 4° C. | 0 |
| Day 148 to 175 | | | |
| Day Length | 8 hours | 5° C. | 700 |
| Night Length | 16 hours | 3° C. | 0 |

### Nutrient Regime

Treatments were initially fertilized immediately after planting (late September 2016) with 15.825 mL of Dutch Nutrient Formula® PNK fertilizer (Table 5.).

TABLE 5
DNF Solution with 15.825 mL diluted
and 6 L applied to new vines.

| NUTRIENT | mg/L | Rate |
|---|---|---|
| N | 211 | 8.0% |
| Ammonical Nitrogen | | 4.0% |
| Nitrate Nitrogen | | 1.60% |
| Water Soluble Nitrogen | | 2.0-4.0% |
| P | 23 | 2.00% |
| K | 66 | |
| Available Phosphate | | 2.00% |
| Soluble Potash | | 3.00% |
| Citric Acid* | | 18.80% |

*Used as a complexing agent

Hoagland solution (composition is presented at Table 6) was added to each experimental unit according to the schedule presented in Table 7. One litter of Hoagland was added to each experimental unit per application. The N concentration was adjusted as excess of N was noticed in Phase I of the experiment.

TABLE 6
Composition of Hoagland solution used for supplemental nutrition.

| | | RATE | | | |
|---|---|---|---|---|---|
| | | | Stock | | mL Stock |
| NUTRIENT | SOURCE | ppm | Solution | | Solution/1 L |
| N | 1M NH₄NO₃ | 210* | 80 | g/L | 1 |
| K | 2M KNO₃ | 235 | 202 | g/L | 2.5 |
| Ca | 1M Ca(NO₃)₂•4H₂O | 200 | 236 g/0.5 L | | 2.5 |
| P | 1M KH₂PO₄ (pH to 6.0) | 31 | 136 | g/L | 0.5 |
| Mg | 0.5M MgSO₄•7H₂O | 48 | 493 | g/L | 4 |
| B | H₃BO₃ | 0.5 | 2.86 | g/L | 1 |
| Fe | Fe•EDTA | 1 to 5 | 15 | g/L | 1.5 |
| Mn | MnCl₂•4H₂O | 0.5 | 1.81 | g/L | 1 |
| Zn | ZnSO₄•7H₂O | 0.05 | 0.22 | g/L | 1 |
| Cu | CuSO₄•5H₂O | 0.02 | 0.051 | g/L | 1 |
| Mo | Na₂MoO₄•2H₂O | 0.01 | 0.12 | g/L | 1 |
| — | 1M CaCl₂•2H₂O* | — | | | 5.0 |

| | | | | |
|---|---|---|---|---|
| S | — | 64 | — | — |

*In the first application, N adjusted to reduce ppm from 210 to 63 ppm. The 1M Ca(NO₃)₂•4H₂O was replaced with 1M of CaCl₂•2H₂O to keep the levels of Ca to 200 ppm

TABLE 7
Application schedule of Hoagland solution.

| | | | Full Strength Hoagland Solution | | | | | | |
|---|---|---|---|---|---|---|---|---|---|
| | Modified Hoagland | | (1 L/box/application) | | | | | | |
| | (⅓ N concentration) | Fe-EDTA and | Day | Day | Day | Day | Day | Day | Day |
| Varieties | Day 1* | CaCl₂•2H₂O** | 18*** | 28 | 42 | 68 | 71 | 83 | 109 |
| Frontenac Noir | Sept 18 | Sept 22 | Oct 6 | Oct 16 | Oct 31 | | Nov 29 | | Jan 6 |
| (growth cycle 2) | | | | | | | | | |
| Syrah and Merlot | Sept 18 | Sept 22 | | | | Nov 26 | | Dec 11 | Jan 6 |
| (growth cycle 1) | | | | | | | | | |

*Modified Hoagland Solution on Day 1: missing iron (Fe-EDTA) and 1M Ca (NO₃)₂•4H₂O. Nitrogen concentration reduced from 210 ppm to 64 ppm in this application to control the excess vigor.
**Fe-EDTA and CaCl₂•2H₂O: missing components of Hoagland. 1M Ca(NO₃)₂•4H₂O substituted by CaCl₂/2H₂O to reduce excess N.
***Hoagland Solution on Day 14 and after: Full strength

### Plant Growth Monitoring

Vine growth observations were collected by picture documentation only. All new vines planted on Sep. 2, 2016 survived and sprouted successfully (see Visual Observations section under RESULTS and DISCUSSIONS section).

### Fresh Weight of Grapes Per Vine

Frontenac Noir Grapes were harvested on Dec. 5, 2016. Yield parameters including number of clusters per vine, berry count, total berry weight and hundred berry weight were measured. Yield quality parameters including Brix, and Yeast Assimilation Nitrogen (YAN) measurements were conducted by Cool Climate Oenology Institute (CCOVI) Laboratory at Brock University. The Titration Acidity (TA) was measured at Trent University. Grape juice was extracted by crushing the grapes and squeezing them through a cheese cloth. Juice pH was measured using a pH meter with glass electrode. Brix represents grams of sugar per 100 mL of juice. Brix was determined using an Abbe benchtop refractometer. Titrable acidity measure the total number of protons available in the grape juice was measured by titration with sodium hydroxide (NaOH) to a pH end-point of 8.2. Yeast Assimilation Nitrogen is important for the fermentation process, if there is not a high enough quantity is needs to be supplemented at times. The YAN was determined using the grape juice and mid-infrared (MIR) spectrometry. Yeast Assimilable Nitrogen (YAN) was calculated from Ammonia and Primary Amino Acid concentrations Amino Acid Nitrogen was determined by enzyme kit K-PANOPA from Megazyme UK Ammonia Nitrogen was determined by enzyme kit K-AMIAR from Megazyme UK.

### Growing Media, pH, Nitrate and Ammonium Concentration at Harvest

After harvest, composite samples (consist of 6 individual samples per box) were collected from the growing media for each planter box. Soil probes were used to take 6 soil cores from random areas of the planter box (low sample volumes were taken to avoid damaging vine roots). Samples were sieved to <2 mm, moist samples were immediately analyzed for mineral N, the rest of the sample was air dried and stored in seal plastic bags until analyses. Growth media were analyzed for pH (1:4 soil to RO water ratio) using a pH probe, and mineral N by extracting the samples with 2M KCl (1:10 soil to solution ratio) followed by supernatant analysis via colourimetry using an Auto-analyzer 3 (Segmented Flow Analyzer).

### Statistical Analysis

Data were analyzed using one way ANOVA test and if significant (α=0.05) means comparison were conducted with a LDS test.

### Wine Grapes Yield

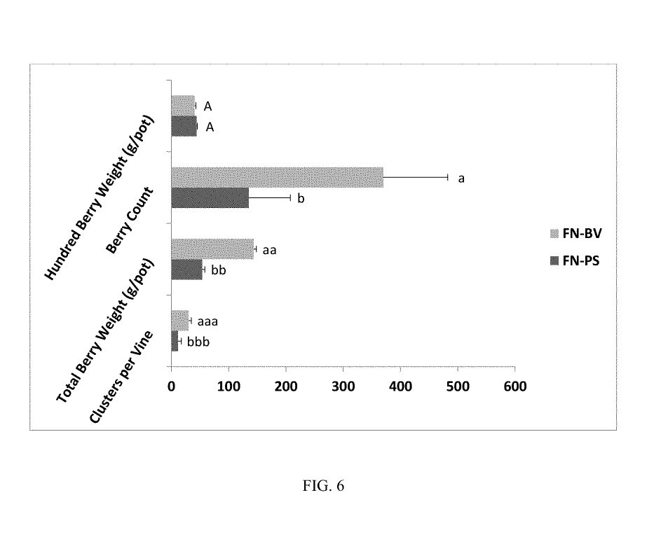

Grape yield only obtained and harvest from Frontenac Noir vines which were in their second life cycle. The vines were not in their full production capacity and the harvest was conducted mainly to evaluate the quality of grapes for wine making. Berry size was not affected by growing media treatment as measured by hundred berry weight (FIG. 6). Grape yields were significantly greater in BV than control (commercial potting soil) though higher number of clusters and greater number of berries on each cluster. Number of clusters, total berry weight and berry count increased by 1.6, 1.7, and 1.7 times in BV treatments compared with control (FIG. 6).

### Wine Grapes Quality

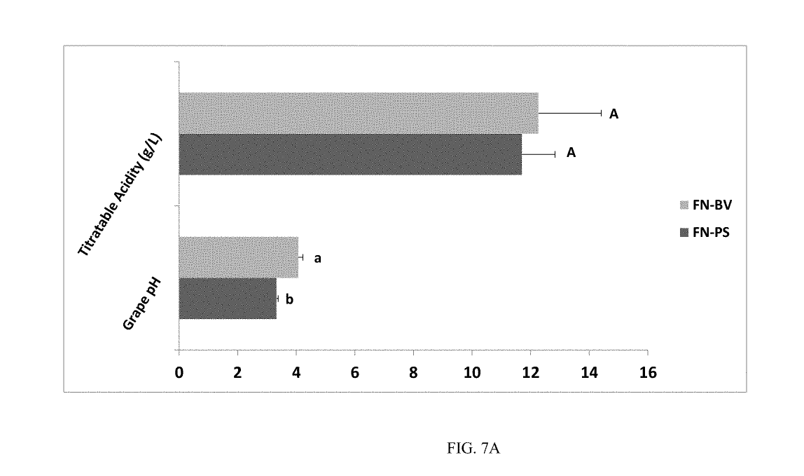

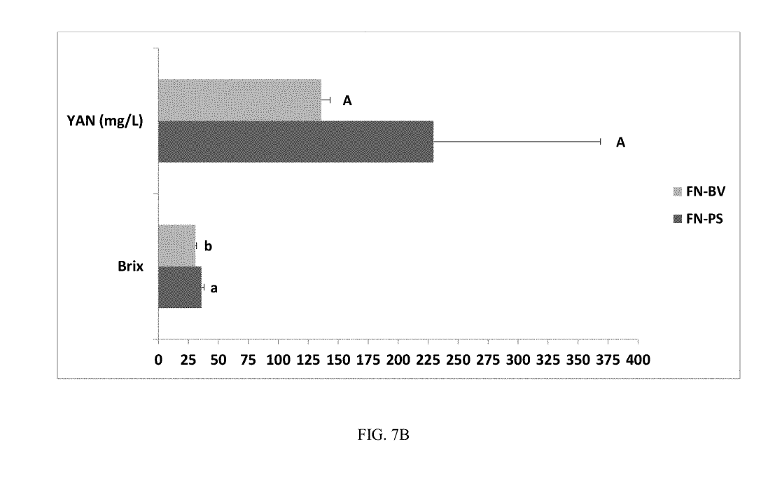

Among yield quality parameters only pH and Brix affected by growing media treatment (FIGS. 7A and 7B). Grape juice pH was 22% higher in BV compared with control and Brix was 14% lower in BV than in control. The growing media composition did not affect TA and YAN.

For table wines, preferred pH levels are 3.1-3.4 for white wines, and 3.3-3.6 for red wines. Proffered Brix is usually above 25. Preferred TA levels are 7-9 g/L for white wines, and 6-8 g/L for red wines. Typical concentrations of free protons in a juice or wine range from ˜0.1 to 1 mg/L, whereas TA values might be 4 to 8 g/L.

The average YAN values for BV treatment was 136 mg/L and for control was 229 mg/L.

### Growing Media, pH, Nitrate and Ammonium Concentration at Harvest

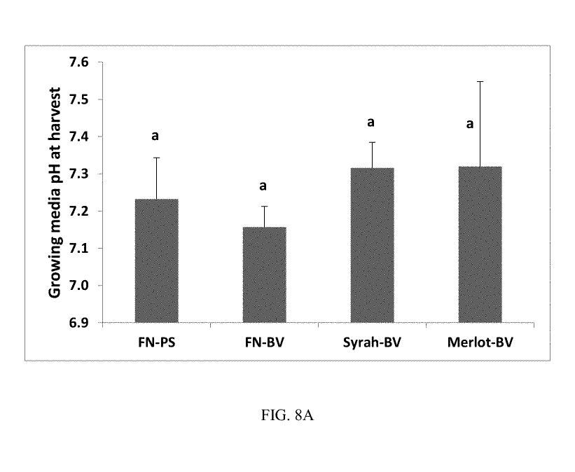

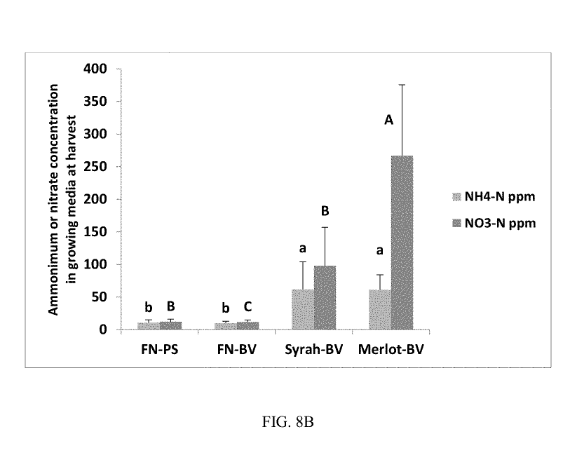

Growing media pH at harvest ranged between 7.16 and 7.32 and was not different among treatments. pH values were within the optimum range for grapes (FIG. 8A). Growing media ammonium and nitrate concentrations for Frontenac Noir vines were not affected by growing media composition, were low (<12 pm) and presented a NH₄⁺:NO₃⁻ ratio of 46/54% (FIG. 8B).

In contrast, ammonium and nitrate concentrations in Syrah and Merlot growing media at harvest were high (62-267 ppm) and presented an excess supply of N for the first growth cycle (FIG. 8B). Nitrate concentrations in Syrah were significantly lower than Merlot (98 vs. 267 ppm) whereas, ammonium concentrations were similar (62 ppm).

### CONCLUSION

The biochar+vermicompost+mycorrhizae (BV) growing media supported Frontenac Noir vines at their second growth cycle, and Syrah and Merlot at their first growth cycle. Frontenac Noir produced berries under growth chamber conditions.

As many changes can be made to the preferred embodiment of the invention without departing from the scope thereof; it is intended that all matter contained herein be considered illustrative of the invention and not in a limiting sense.

1-56. (canceled)

57. A growing media for growing a grape variety in a controlled environment; said media comprising soil, at least one soil enhancer, and compost,
wherein said soil is potting soil, said soil enhancer is charcoal and said compost is vermicompost,
wherein said potting soil comprises at least one of: i) sphagnum peat moss, coir, perlite, a wetting agent, at least one of the following: processed forest products, peat, and/or compost); ii) a minimum of about 0.21% N, a minimum of about 0.11% P₂O₅ and a minimum of K₂O of about 0.16% based on F1144 analysis; and combinations thereof, and fertilizer,
wherein said fertilizer comprises Nitrogen (N), Phopshate (P₂O₅) and Potash (K₂O),
wherein said Nitrogen is from ammoniacal nitrogen, nitrate nitrogen and combinations thereof, said Phosphate is available Phosphate and said Potash is soluble Potash.

58. The growing media of claim 57 wherein said minimum of about 0.21% N comprises about 0.113% ammoniacal nitrogen and about 0.097% nitrate nitrogen.

59. The growing media of claim 57 wherein a portion of the Nitrogen, Available Phosphate and Soluble Potash are in a slow release form.

60. The growing media of claim 57 wherein said charcoal is biochar.

61. The growing media of claim 57 wherein said growing media comprises from about 30% to about 90% potting soil, from about 5% to about 30% biochar, and from about 5% to about 50% vermicompost (worm casting).

62. The growing media of claim 57 wherein said growing media comprises about 70% potting soil, about 15% biochar, and about 15% vermicompost (worm casting).

63. The growing media of claim 57 further comprising Mycorrhizal fungi inoculant.

64. The growing media of claim 63 wherein said Mycorrhizal fungi inoculant is added at the onset of a first growth cycle.

65. The growing media of claim 63 wherein said Mycorrhizal fungi inoculant is at a concentration of about 54 mg inoculant/L water.

66. The growing media of claim 57 wherein said grape variety is selected from the group consisting of Frontenac Noir, Merlot, Syrah.

67. The growing media of claim 57 wherein said controlled environment is a greenhouse.

68. A method of fertigation of grapes comprising introducing, over a predetermined period and predetermined frequency, at least one nutrient to growing media of claim 57.

69. The method of claim 68 wherein said at least one nutrient comprises at least one nutrient selected from the group consisting of N, K, Ca, P, Mg, B, Fe, Mn, Zn, Cu, Mo, S and combinations thereof.

70. The method of claim 68 wherein said at least one nutrient is selected from a combination of N, P, and K.

71. The method of claim 68 wherein said at least one nutrient further comprises a complexing agent.

72. The method of claim 71 wherein said complexing agent is citric acid.

73. The method of claim 68 wherein said at least one nutrient is introduced to said growing media before, during or after at least a new grapevine is planted in said growing media.

74. The method of claim 73 wherein said at least on nutrient is a combination of N, P, K, P₂O₅ and K₂O and optionally citric acid.

75. The method of claim 74 wherein said combination comprises 211 mg/L N (8.0%), 23 mg/L P (2.0%), 66 mg/L K (3.0%), available phosphate (2.0%), soluble potash (3.0%) and optionally citric acid (18.8%).

76. The method of claim 68 further comprising supplemental nutrition comprising at least one nutrient selected from the group consisting of N, K, Ca, P, Mg, B, Fe, Mn, Zn, Cu, Mo, S and combinations thereof.

77. The method of claim 76 wherein said supplemental nutrition comprises a mixture of N from about 63 to 210 ppm, K at about 235 ppm, Ca at about 200 ppm, P at about 31 ppm, Mg at about 48 ppm, B at about 0.5 ppm, Fe from about 1 to 5 ppm, Mn at about 0.5 ppm, Zn at about 0.05 ppm, Cu at about 0.02 ppm, Mo at about 0.01 ppm and S at about 64 ppm.

78. A feeding regimen for an indoor grape growing system, said regimen comprising the introduction of a combination of N, P, K, phosphate, potash and citric acid on or about the first day of a growth cycle,
wherein said combination comprises 211 mg/L N (8.0%), 23 mg/L P (2.0%), 66 mg/L (K), available phosphate (2.0%), soluble potash (3.0%) and optionally citric acid (18.8%),
further comprising introduction of a combination of N, K, Ca, P, Mg, B, Fe, Mn, Zn, Cu, Mo and S, wherein said combination is a mixture of N from about 63 to 210 ppm, K at about 235 ppm, Ca at about 200 ppm, P at about 31 ppm, Mg at about 48 ppm, B at about 0.5 ppm, Fe from about 1 to 5 ppm, Mn at about 0.5 ppm, Zn at about 0.05 ppm, Cu at about 0.02 ppm, Mo at about 0.01 ppm and S at about 64 ppm.

79. The feeding regimen of claim 78 wherein said combination is introduced to said system on day 1, day 14, day 18, day 28, day 42, day 68, day 71, day 83 and day 109 of said growth cycle.

80. The feeding regimen of claim 78 wherein said mixture is introduced to said system on day 1, day 14, day 18, day 28, day 42, day 68, day 71, day 83 and day 109 of said growth cycle.

81. The method of claim 68 comprising control of climate conditions through a controlled environment wherein said controlled environment comprises at least one of the following: i) humidity level conducive to grape growing, ii) a controlled CO₂ level, iii) a controlled temperature, iv) a controlled lighting condition, v) a controlled dark condition, and combinations thereof.

82. The method of claim 81 further comprising at least one of the following: i) said humidity level is from about 50-60% R.H., ii) said controlled CO₂ level is about 502 ppm, iii) said controlled temperature is from between about 3° C. to about 27° C., depending on the period during a growth cycle, iv) said controlled lighting comprises a lighting length between about 8 hours to about 16 hours per day, depending on the period during the growth cycle, v) said controlled dark condition comprises a dark length between about 8 hours to about 16 hours per day, depending on the period during the growth cycle, vi) said lighting length provides solar radiation to said controlled environment, preferably about 700 μmol m⁻² s⁻¹, and combinations thereof.

83. The method of claim 81 wherein said controlled lighting, dark and temperature conditions are as follows:

| | Day | Dark | | Solar |
|---|---|---|---|---|
| Days after | (Light) | (Night) | Temperature | Radiation |
| transplant of | Length | Length | Day/Night | Day/Night |
| grape vine | hours | hours | ° C. | μmol m⁻² s⁻¹ |
| 1 to 38 | 16 | 8 | 22/19 | 700/0 |
| 39 to 119 | 16 | 8 | 27/22 | 700/0 |
| 120 to 122 | 14 | 10 | 23/18 | 700/0 |
| 123 to 124 | 14 | 10 | 19/14 | 700/0 |
| 125 to 128 | 12 | 12 | 15/10 | 700/0 |
| 129 to 134 | 12 | 12 | 11/6 | 700/0 |
| 135 to 147 | 10 | 14 | 9/4 | 700/0 |
| 148 to 175 | 8 | 16 | 5/3 | 700/0 |

84. A growing media for growing deep root plants in a controlled environment; said media comprising soil, at least one soil enhancer, and compost.

85. The growing media of claim 84 wherein said soil is potting soil, said soil enhancer is charcoal and said compost is vermicompost.

86. The growing media of claim 84 wherein said controlled environment is an indoor environment.

87. The growing media of claim 84 wherein said potting soil comprises sphagnum peat moss, coir, perlite, a wetting agent, at least one of the following: processed forest products, peat, and/or compost), and fertilizer.

88. A method of growing deep root plants comprising introducing, over a predetermined period and predetermined frequency, at least one nutrient to growing media of claim 84.
